(19) United States
(12) Patent Application Publication
(10) Pub. No.: US 2015/0339006 A1
(43) Pub. Date: Nov. 26, 2015

(54) Asynchronous Preparation of Displayable Sections of a Graphical User Interface

(71) Applicant: Facebook, Inc., Menlo Park, CA (US)

(72) Inventors: Christophe Chaland, Saratoga, CA (US); Jonathan M. Kaldor, San Mateo, CA (US); Robert Douglas Arnold, San Francisco, CA (US)

(21) Appl. No.: 14/622,463

(22) Filed: Feb. 13, 2015

Related U.S. Application Data
(63) Continuation-in-part of application No. 14/284,304, filed on May 21, 2014.

(51) Int. Cl. G06F 3/0482; G06F 3/0485; G06F 3/048

(52) U.S. Cl. CPC G06F 3/0482; G06F 3/048; G06F 3/04855

(57) ABSTRACT

Particular embodiments of a computing device include a main thread, a graphics thread, and an input thread. The main thread may execute instructions to generate an object representation of a GUI for an application. Copies of the object representation may be provided to the graphics thread and the input thread. The main thread may determine which displayable sections to render based on user input information, a current location with respect to the GUI, and a caching pattern. The caching pattern may include a first section and one or more second sections adjacent to the first section in one or more directions. The main thread may render the those displayable sections and cache some of the sections. The graphics thread may then asynchronously execute instructions to draw one of the rendered sections into a frame buffer.

### PRIORITY

This application is a continuation-in-part claiming priority under 35 U.S.C. §120 to U.S. patent application Ser. No. 14/284,304, filed 21 May 2014, which is incorporated herein by reference in its entirety.

### TECHNICAL FIELD

This disclosure generally relates to handling graphical user interfaces.

### BACKGROUND

A computing device may render a graphical user interface (GUI) for display. In some cases, it may be possible to interact with certain components of a GUI. The view displayed by the GUI (and therefore, the particular set of components comprising the GUI) may change as user input is received in relation to interactive components of the GUI (e.g., through a gesture, such as scrolling or clicking/tapping). In some cases, for example, when a user is rapidly scrolling through a list of content items or skipping back and forth between tabs, the GUI may need to be updated quickly in order to avoid visual lag.

Conventionally, all instructions for any particular application may be handled by a single thread (i.e., the main execution thread). A significant portion of the instructions handled by the main execution thread may include generating and/or updating a view of a GUI for the application, as well as handling user input received in relation to particular components of the GUI. Latency attributable to GUI-related input (e.g., processing touch sensor data to identify a gesture) and output (i.e., updating the GUI in response to received user input) tasks may increase significantly as the GUI becomes more complex (e.g., when animations are presented in the GUI) and/or as particular components of the GUI become more expensive to render.

### SUMMARY

Particular embodiments provide various techniques for asynchronous execution of instructions for an application using a multi-threaded approach to outsource input/output (I/O)-handling tasks from a main thread to an input-handling thread and a graphics thread. Particular embodiments may use the main thread to generate an object representation of a graphical user interface (GUI) for an application. Particular embodiments may define displayable sections of the GUI, where each displayable section may fill the entire screen. Particular embodiments may use (1) the main thread to handle execution of instructions to generate a hierarchy of layers representing a GUI, wherein each layer represents a logical grouping of components of the GUI, (2) the input thread to handle asynchronous execution of instructions to process user input based on interactions with the GUI, and (3) the graphics thread to handle asynchronous execution of instructions to generate and/or update display output in relation to one or more layers of the GUI hierarchy. These techniques may result in a reduction in latency associated with generating and/or updating a view of a GUI for the application, as well as a reduction in latency associated with handling user input received in relation to particular components of the GUI.

Certain tasks may be handled by an animation engine executing within the context of the input thread and the graphics thread. In particular embodiments, the input thread may maintain a canonical copy of the animation engine, including the canonical copy of any animation-state variables for animated GUI components. The input thread may periodically copy over any data associated with the animation engine to the copy of the animation engine executing within the context of the graphics thread. By way of example and not limitation, tasks handled by the animation engine may include: tracking animation-state variables for animated GUI components, calculating updated values for the animation-state variables, and handling user input that triggers or affects animation within the GUI. Such user input may include recognizing user input types and handling tasks based on the type of animation to which the user input is applied. In some embodiments, certain tasks handled by the animation engine may be variously performed by the input thread, the graphics thread, and the main thread; in some embodiments, certain tasks may be assigned to different threads than as described above. In particular embodiments, the input thread and the graphics thread may be able to independently and asynchronously handle their respective tasks for the animation engine. By way of example and not limitation, the graphics thread may execute its tasks upon each frame draw and according to a prescribed framerate, while the input thread may execute its tasks on a slower schedule and/or whenever input is detected.

Particular embodiments may define displayable sections of the GUI, where each displayable section may fill the entirety of a particular region designated for displaying a scrollable list (e.g., the whole screen, a window, or a frame). Particular embodiments may use the graphics thread to handle asynchronous execution of instructions to (1) determine which displayable sections of the GUI to render; (2) render those sections; (3) draw one of the rendered sections into a frame buffer; and (4) cache the other rendered sections. Particular embodiments may use the main thread to handle asynchronous execution of instructions to render the entire GUI and then use the graphics thread to (1) determine which displayable sections of the GUI should be currently displayed; (3) draw one of the rendered sections into a frame buffer; and (4) cache the other rendered sections. In particular embodiments, one or more of the cached sections may be adjacent to the rendered section drawn into the frame buffer. These techniques may result in a reduction in latency associated with generating and/or updating a view of a GUI for the application.

Particular embodiments may be implemented on any platform that follows the Model View ViewModel (MVVM) architectural pattern, in which a clear separation is facilitated between software instructions related to the GUI and software instructions related to business logic.

### BRIEF DESCRIPTION OF THE DRAWINGS

FIG. 1A illustrates an example GUI for a newsfeed.

FIG. 1B illustrates a detailed view of a newsfeed item from FIG. 1A.

FIG. 1C illustrates an updated view of the example GUI of FIG. 1A showing animation of a strip of images in the newsfeed item.

FIGS. 1D-F illustrate updated views of the example GUI of FIG. 1C after receiving user input.

FIGS. 1G-I illustrate updated views of the example GUI of FIG. 1A after receiving user input to scroll horizontally through tabs.

FIG. 1J illustrates an example GUI for a chat message interface.

FIGS. 1K-M illustrate updated views of the example GUI of FIG. 1A after receiving user input to scroll horizontally through tabs.

FIG. 1N illustrates an updated view of the example GUI of FIG. 1A after receiving user input to scroll vertically down through the newsfeed.

FIG. 1O illustrates an updated view of the example GUI of FIG. 1A that displays a header bar after receiving user input to scroll vertically back up through the newsfeed.

FIG. 2 illustrates a GUI hierarchy based on the example GUI of FIG. 1A.

FIG. 3 illustrates example displayable sections of the example GUI of FIG. 1C.

FIG. 4 illustrates example displayable sections of the example GUI of FIG. 1J.

FIGS. 5A-D illustrate example patterns for generating and caching displayable sections.

FIG. 6 illustrates an example method for asynchronous execution of instructions.

FIG. 7 illustrates an example network environment associated with a social-networking system.

FIG. 8 illustrates an example social graph.

FIG. 9 illustrates an example computer system.

### DESCRIPTION OF EXAMPLE EMBODIMENTS

In particular embodiments, various techniques are provided for asynchronous execution of instructions for an application using a multi-threaded approach to outsource input/output (110)-handling tasks from a main thread to an input-handling thread and a graphics thread. Particular embodiments may use (1) the main thread to handle business logic, including execution of instructions to generate a hierarchy of layers representing a graphical user interface (GUI), wherein each layer represents a logical grouping of components of the GUI, (2) the input thread to handle asynchronous execution of instructions to process user input based on interactions with the GUI, and (3) the graphics thread to handle asynchronous execution of instructions to generate and/or update display output in relation to one or more layers of the GUI hierarchy. User input processed by the input thread is then passed to both the main thread and the graphics thread, so that the graphics thread may begin immediately updating the GUI without waiting for the user input to the processed by the main thread.

In particular embodiments, an animation engine may execute within the contexts of the input thread and the graphics thread to handle certain animation-related tasks, such as, by way of example and not limitation: calculating animation state, tracking animation-state variables, and, by way of copying the input tree to memory reserved for the graphics thread, providing rendering instructions for animations. The main thread may handle rendering of frames for the animations in accordance with instructions provided by the input thread and in accordance with the frame rate, and the graphics thread may handle drawing such rendered frames to a display output device (e.g., framebuffer). In particular embodiments, the main thread may still perform the initial setup of the animation environment, e.g., when a gesture triggers an animation. After that initial step, however, all animation-related operations (for the newly-triggered animation) are handled by the animation engine. In particular embodiments, the animation engine may be able to determine (e.g., by identifying and classifying) particular types of user input received with respect to animations, calculate and update animation-state variables accordingly, and thereby instruct the graphics thread and/or the main thread appropriately. Particular embodiments of this multi-threaded model for handling execution of tasks may thereby enable smoother animations, provide quicker GUI response time to user input received with respect to animations, and facilitate interactive features for animated GUI components (e.g., by handling tasks to trigger or conclude an animation or to temporarily or permanently modify an animation).

In particular embodiments, components of a GUI may be organized into logical groupings organized as a hierarchy of layers in the GUI. The GUI hierarchy may be represented by a tree data structure, comprising a root node, a number of intermediary nodes, and a number of leaf nodes. Each node may represent a layer, and each layer may include one or more GUI components. Certain GUI components may include interactive features and/or animations.

Particular embodiments maintain a canonical version of this GUI hierarchy in memory for the main thread for application execution, while making copies of the GUI hierarchy for use by other threads: one stored in memory for an input thread for use in processing data received from input devices, and one stored in memory for a graphics thread for use in rendering the GUI to a display device. By outsourcing input-processing tasks to a separate input thread and outsourcing display-output tasks to a separate graphics thread, such tasks may be handled asynchronously, thereby speeding up processing of input data, drawing the GUI, and overall execution time for the application.

Particular embodiments may define displayable sections of the GUI, where each displayable section may fill the entirety of a particular region designated for displaying a scrollable list (e.g., the whole screen, a window, or a frame). Particular embodiments may use the main thread and/or the graphics thread to handle asynchronous execution of instructions for various tasks to (1) determine which displayable sections of the GUI to render; (2) render those sections; (3) draw one of the rendered sections into a frame buffer; and (4) cache the other rendered sections. In particular embodiments, the rendered sections drawn into a frame buffer may be adjacent to the rendered section drawn into the frame buffer in one or more directions. Upon receiving user input requesting a different displayable section, if the requested displayable section has already been rendered and cached, then the cached rendered section is retrieved and displayed, otherwise the requested displayable section is rendered and displayed. In either case, the position of the currently displayed displayable section within the GUI is assessed and, if need be, additional displayable sections may be rendered and cached.

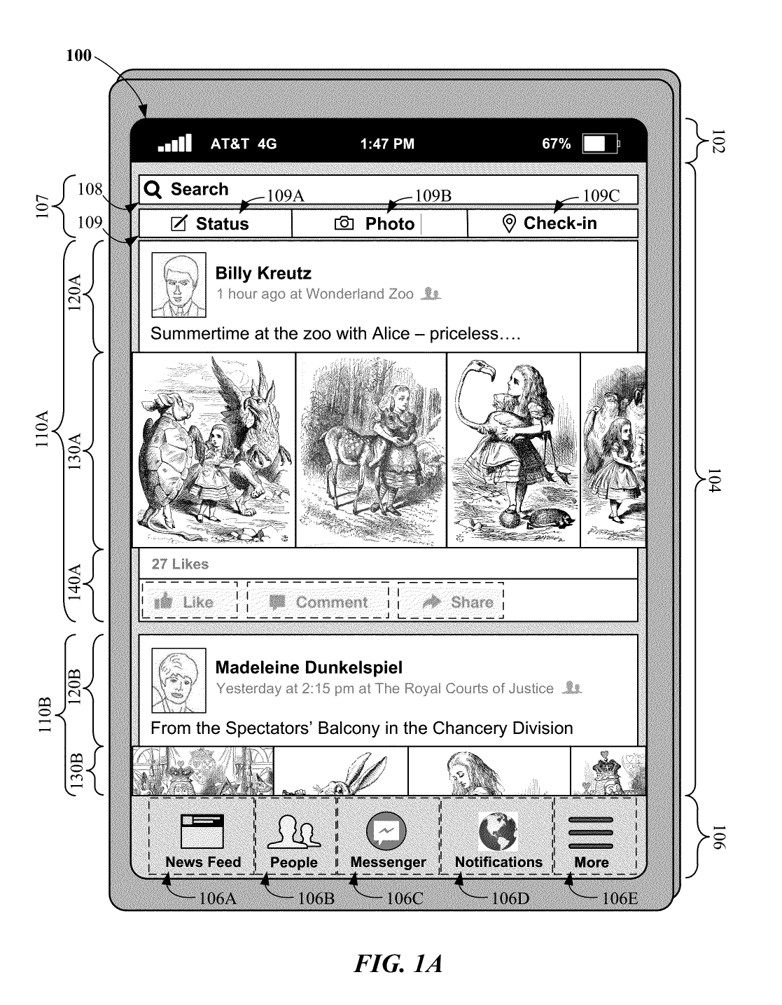

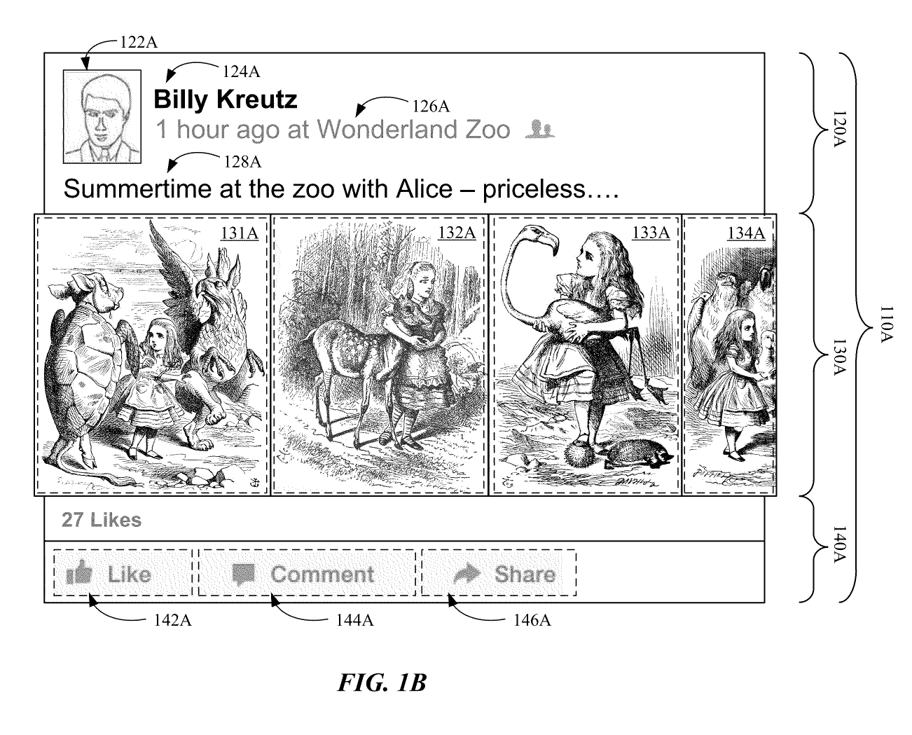

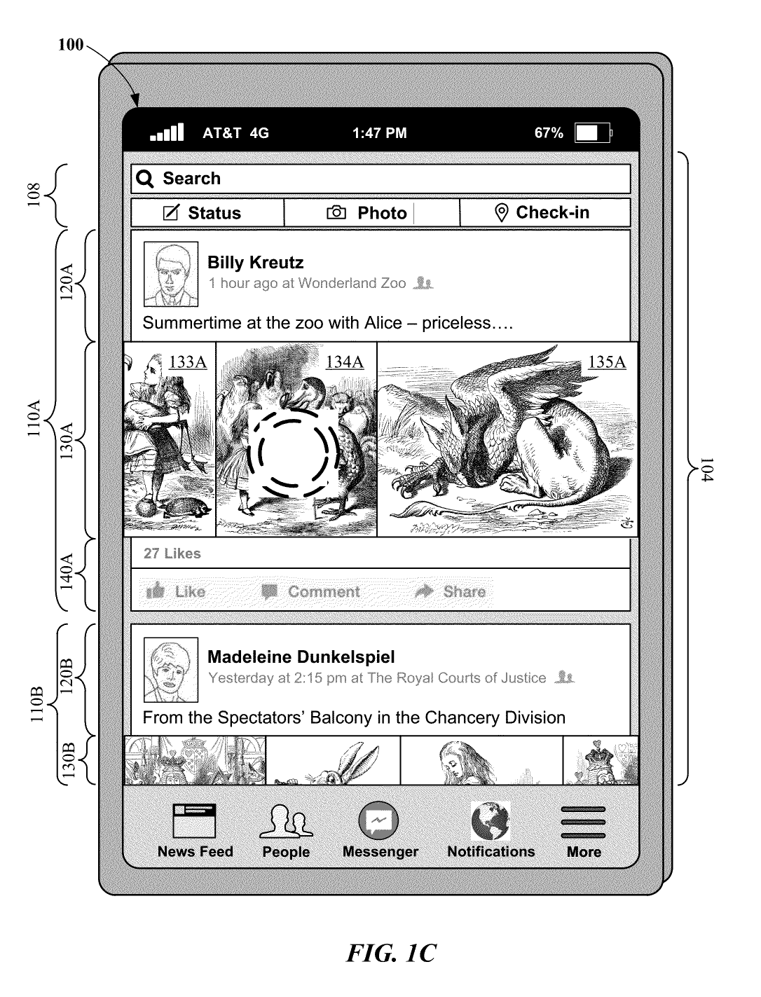

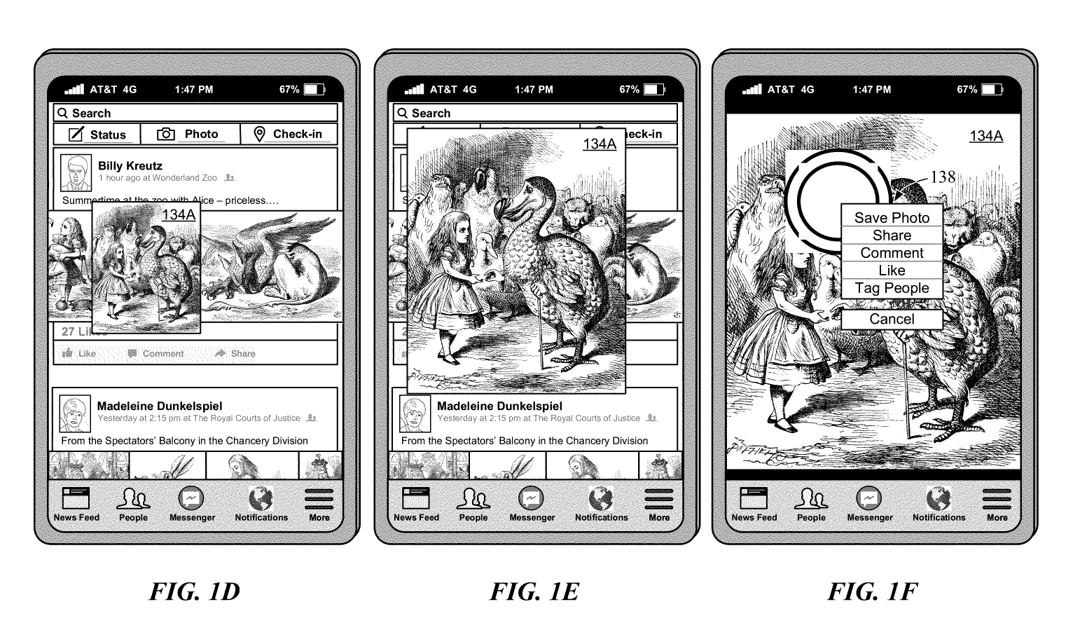

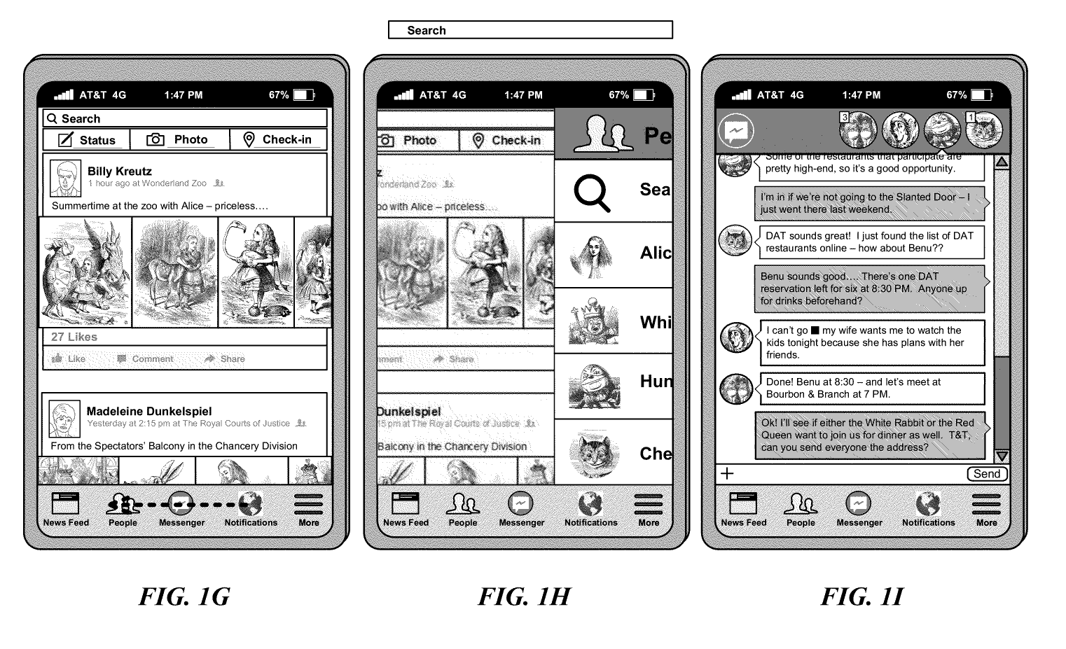

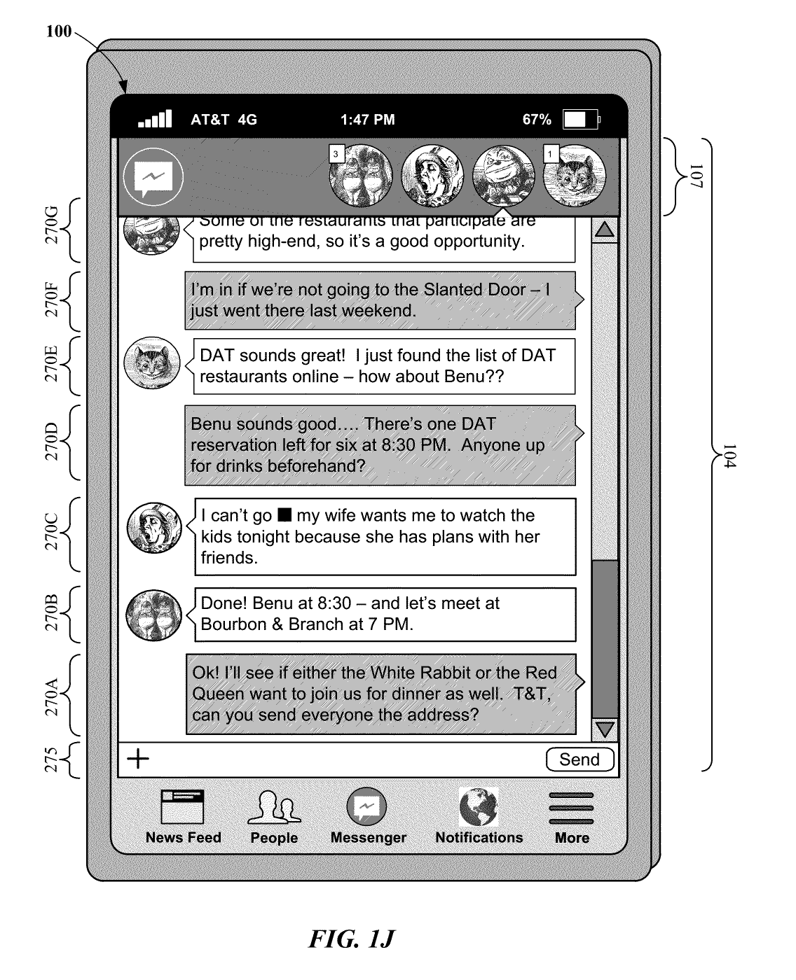

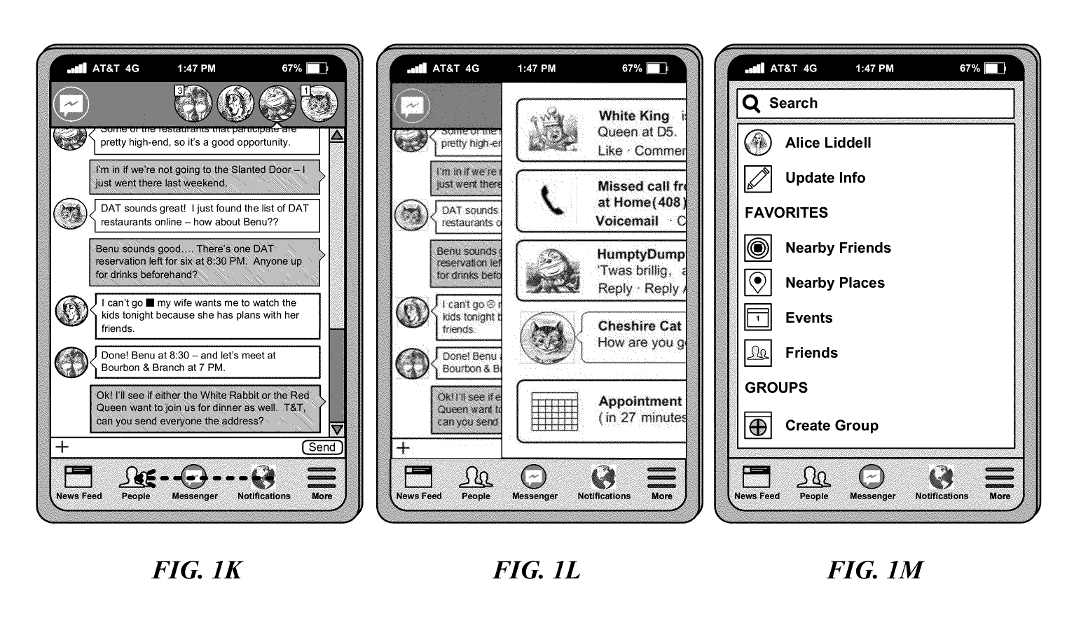

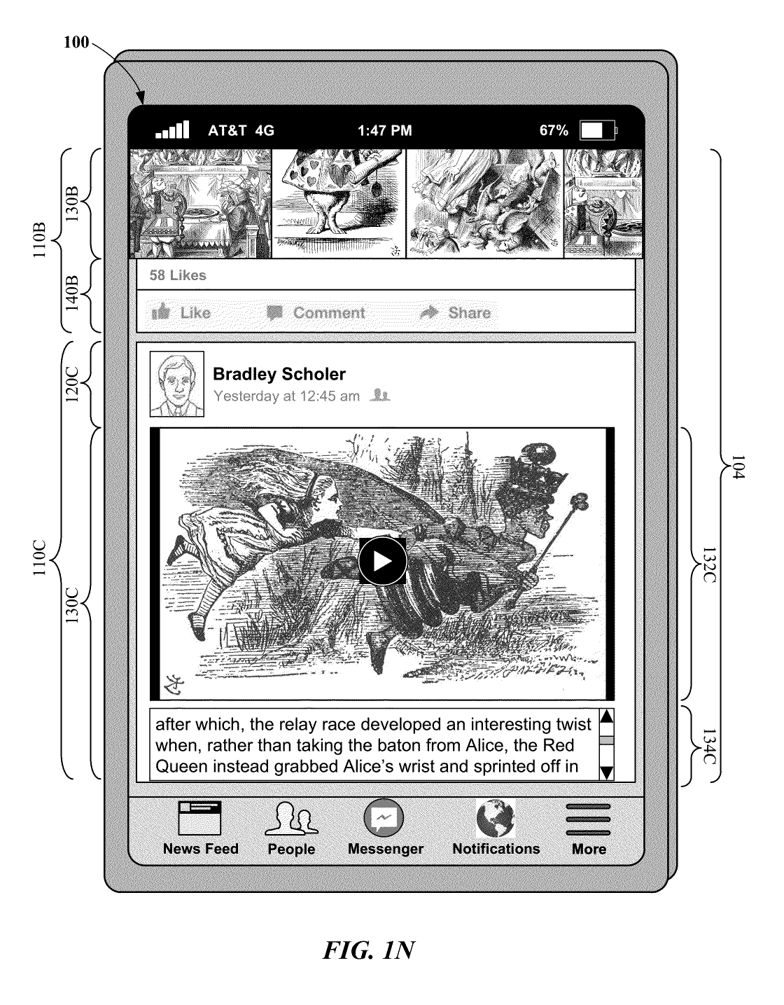

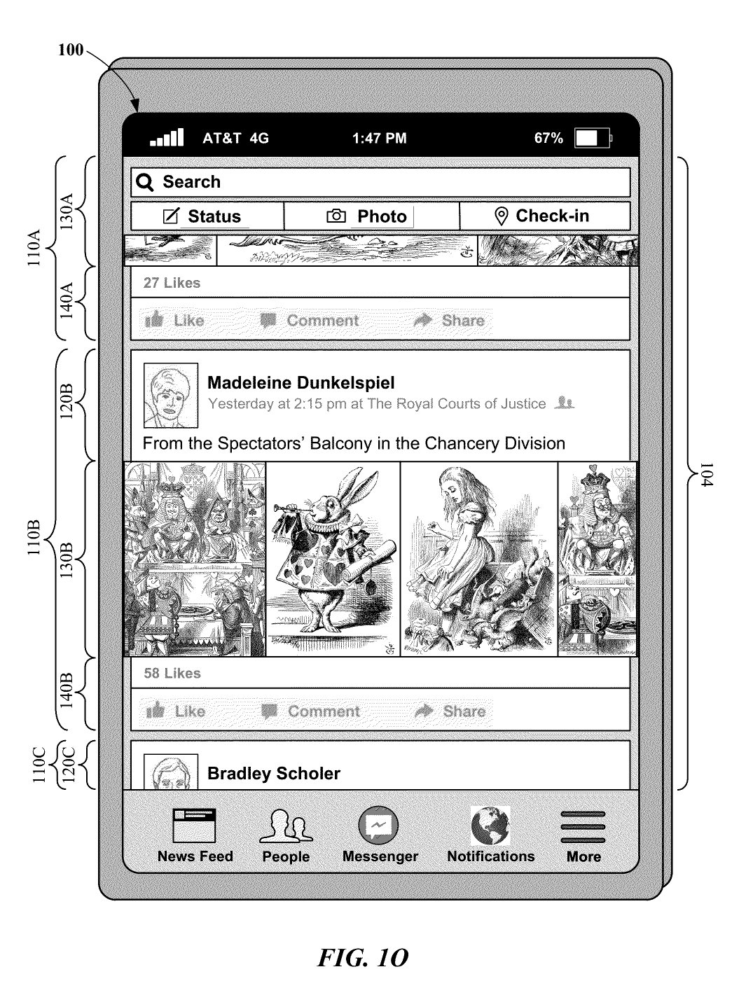

FIG. 1A illustrates an example GUI for a newsfeed comprised of a variety of components, some of which may include interactive features and/or animations. GUI 100, as displayed on a mobile device with a touchscreen includes several different static components, including status bar 102, content display region 104, and menu bar 106—in normal use (e.g., when the orientation of the device remains static), the position and/or dimensions of these regions may be fixed. Status bar 102 may display general status information, including the time (the format may be user-configurable), power status (e.g., whether the device is being charged or running on battery power, and how much battery capacity remains), and network information (identification of any network to which the mobile device is connected, as well as the strength of the network signal). Menu bar 106 may display a number of different menu buttons corresponding to different tabs, including “News Feed” button 106A, “People” button 106B, “Messenger” button 106C, “Notifications” button 106D, and “More” button 106E. The interactive regions for each of these buttons is shown by the dashed line. Within the dashed line for a particular button, a tap gesture may be detected and applied as user input indicating that the particular tab has been selected. Within the region covered by menu bar 106, a horizontal swipe gesture may be detected and applied as user input indicating that the user wishes to jump to a different tab.

Content display region 104 may detect and apply vertically-scrolling user input to reveal additional entries in the list of news feed items 110. In the view shown in FIG. 1A, region 104 includes three GUI components: header 107 (comprising search box 108, which may be tapped in order to begin receiving character input, and publisher bar 109, which may include interactive menu buttons 109A-C to allow the user to tap to post a “Status” message, upload a “Photo,” or “Check-in” to a location) and news feed items 110A and 110B. Each news feed item 110 itself includes a number of GUI components: a header section 120, a posted-content section 130, and an interaction section 140. As shown with respect to news feed item 110A, header section 120A may include various GUI components, such as personal information associated with a poster of news feed item 110A and information related to news feed item 110A itself. Posted-content section 130A includes an interactive animated strip of images that may detect and apply horizontally-scrolling user input to display additional images uploaded to news feed item 110A. Interaction section 140A includes status information about user interactions with news feed item 110A as well as several interactive button regions (as shown by the dashed lines).

In particular embodiments, a strip of images in a posted-content section 130 (e.g., 130A or 130B) may be animated, such that by default, a number of images associated with the corresponding newsfeed item 110 (more than can be displayed in the strip at once) slowly scroll from the right side of the screen to the left side of the screen (as indicated by the heavy dashed arrow in FIG. 1A). The animation for a strip of images may commence once the entire strip (with respect to the height of the strip) is within the displayable region of the GUI (e.g., either upon loading content display region 104, as is the case for posted-content section 130A), or once a gesture of a sufficient magnitude of vertical scroll to bring the entire strip within content display region 104 is detected (as is the case for posted-content section 130B as shown in FIG. 1N).

In particular embodiments, the animation engine may compute and track animation-state variables for an animated GUI component such as a strip of images may include, by way of example and not limitation: a default speed of scroll and whether user input temporarily accelerating the speed of scroll has been received (e.g., by recognizing a horizontal swipe gesture in the region of the strip of images, calculating velocity/acceleration/duration of the gesture, and determining a corresponding magnitude and duration for the temporary acceleration). In particular embodiments, the main thread may initialize such animation-state variables and store them as part of the GUI hierarchy in association with the node representing the animated GUI component (e.g., as additional attributes associated with the node representing the animated GUI component, or in an attribute node connected by an edge to the node representing the animated GUI component). When the GUI hierarchy (including the animation-state variables) is subsequently copied from memory allocated for the input thread to memory allocated for the graphics thread, the graphics thread thereby receives instructions regarding how to draw the frames in accordance with the animations. In alternate embodiments, the input thread may add such animation-related node attributes or attribute nodes to the GUI hierarchy as user input triggering an animation is received; in such cases, the updated GUI hierarchy may then be copied from memory allocated for the input thread to memory allocated for the main thread.

FIG. 1B illustrates a detailed view of news feed item 110A in the example GUI of FIG. 1A. As shown, header section 120A may include various GUI components, such as a photo 122A associated with a poster of news feed item 110A, a name 124A of the poster, timestamp and location information 126A related to news feed item 110A, and a caption 128A submitted by the poster for news feed item 110A. Each image (e.g., 131A-135A) in the animated strip of images in posted-content section 130A may itself be an interactive GUI component for which a tap gesture may be applied to zoom in on the individual image. The interactive region for each of the buttons 142A, 144A, and 146A in interaction section 140A is shown by a dashed line; within the dashed line, a tap gesture may be detected and applied as user input indicating that the button has been selected.

FIG. 1C illustrates an updated view starting from the example GUI of FIG. 1A by showing an updated state of the animation for the strip of images in posted-content section 130A. As shown in FIG. 1C, the animation has advanced the strip to display images 133A-135A. In particular embodiments, the animation for the strip of images may have interactive features. For example, a horizontal swipe gesture (to the left or to the right, substantially within or starting within the region occupied by the strip of images) may temporarily accelerate the rate of scroll of images in the strip of images (wherein the duration and/or magnitude of acceleration may correspond to: the detected velocity or acceleration of the swipe gesture, the detected pressure in association with the swipe gesture, and/or the detected number of fingers involved in the swipe gesture). After the duration of acceleration has concluded, the rate of scroll may then decelerate and resume scrolling at the default scrolling rate. Other gestures may trigger other animations—for example, a pinch-zoom-out gesture on a strip of images that triggers an animation of the strip expanding into a grid of images (such that more of the images associated with the corresponding newsfeed item 110 can be viewed simultaneously). In another example, a “tap” gesture—a relatively quick gesture that is substantially shorter than the duration of a long press gesture (e.g., as shown over image 134A by the two concentric circles with broken lines)—on a particular photo in the strip of images may trigger an animation of the particular photo slowly growing (e.g., zooming in) to fill the screen in at least one dimension.

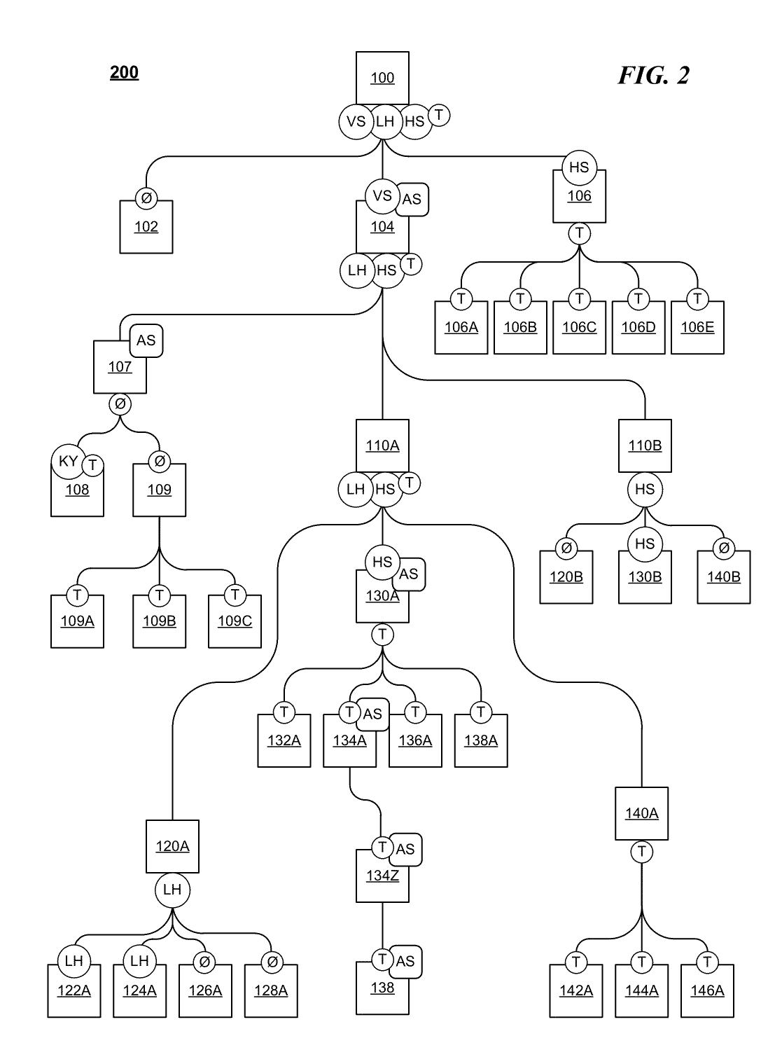

The gesture manager may receive data generated by the touchscreen sensing the tap gesture, wherein the data comprises coordinates detected at one or more particular times. The gesture manager may then determine the input type as a tap gesture and compute the location of the tap gesture with respect to the current GUI layout. After the location has been computed, the gesture manager may traverse the copy of the GUI hierarchy stored in memory for the gesture manager, in order to identify which layers are (1) registered to receive tap gestures and (2) include the location of the tap gesture within their perimeters. In this example, the location of the tap gesture was within the perimeter of the layer for image 134A, and therefore also within the perimeter of the layer for posted-content section 130A, the layer for news feed item 110A, the layer for content display region 104, and the top-level layer for GUI 100; however (as later described with respect to FIG. 2), only the layer for image 134A is registered to receive tap gestures, and so the tap gesture user input is applied to the layer for image 134A. Once the gesture manager determines the parameters and type of received user input, as well as identifying the layer(s) that should receive the user input, the gesture manager may then pass information about the gesture to the main thread and to the graphics thread at the same time.

In particular embodiments, since the user input triggered a zoom animation for image 134A, at this point, the main thread may initialize the animation-state variables for the zoom animation and store them as part of the updated GUI hierarchy in association with the node representing the animated GUI component; in particular embodiments, such tasks may be handled by the animation engine. In particular embodiments, the final zoomed-in version of image 134A may be represented by an additional node in the GUI hierarchy (e.g., node 134A in FIG. 2).

The main thread may perform other business logic-related tasks, such as, downloading a higher-resolution version of image 134A prior to zooming in, assessing how much battery power is remaining and the type of network to which the mobile device is connected (in order to ensure whether the device can afford to download the higher-resolution image), recording the fact that the user zoomed in on image 134A, and retrieving additional metadata and/or interactive features related to image 134A.

Since the graphics thread has already received the user input from the input thread, it need not wait for the main thread and may begin to asynchronously and immediately refresh the display output to display frames of an animation zooming in on image 134A. Once the main thread provides the updated copy of the GUI hierarchy for use by the graphics thread, the graphics thread may update the zoomed-in version of image 134A with information added by the main thread (e.g., by adding additional GUI components, such as tags and comments on image 134A, and/or interactive features related to the zoomed-in version of image 134A).

FIGS. 1D-F illustrate an animation of image 134A zooming in to fill content display region 104. FIG. 1F further illustrates an updated view of the zoomed-in image 134A after receiving user input to display a menu of options. The animation engine may compute and update the animation-state variables for the zoom animation for the image such as, by way of example and not limitation: a default speed of zoom and/or a final size for the zoomed-in image (e.g., based on a zoom mode, such as intermediate letterbox or full-screen). As shown in FIG. 1F, the zoomed-in version of image 134A may provide additional interactive features. For example, detection of user input identified as a “long hold” gesture—where the user presses a finger to the touchscreen and holds the finger in contact with the screen for at least 2 seconds (e.g., as shown over image 134A by the two concentric circles with solid lines)—over the zoomed-in image may trigger an animation of pop-up menu 138 appearing.

The gesture manager may determine the gesture parameters and identify the type of received user input as a long hold gesture, as well as identifying the layer(s) that should receive the user input. Since the user input triggered a pop-up menu animation for image 134A, at this point, corresponding animation-state variables (e.g., which pop-up menu to display, how quickly to animate appearance of the pop-up menu, where the pop-up menu should be positioned during the animation, whether to enlarge the pop-up menu) may be initialized, stored in the GUI hierarchy, and updated.

FIGS. 1G-I illustrate updated views of the example GUI of FIG. 1A after receiving user input to scroll horizontally through tabs 106A-106C. FIGS. 1G-I and FIGS. 1K-1M) represent an animation that may play upon detecting a swipe gesture across the tabs in menu bar 106 (as shown in FIG. 1G). The animation shown in FIG. 1H displays a transition from a starting-point tab (the “News Feed” tab in FIG. 1G) to the subsequent tab (the “People” tab in FIG. 1H, and eventually to the “Notifications” tab in FIG. 1I). In particular embodiments, similar GUI structures allowing for swipe-based horizontal scrolling may be provided for subregions of the GUI, such as the strip of images in posted-content section 130A; such a GUI structure may also be able to respond to swipes detected with respect to that subregion by transitioning between displayable sections of the subregion.

FIG. 1J illustrates an example GUI for a chat message interface. The chat messages may be represented as a content list comprising a number of content items (e.g., the chat messages 270A-G). As shown in FIG. 1J, this content list is displayed within an even more constrained area for a displayable section, due to the persistent presence of chat UI header 107 and text entry field 275 within content display region 104. Although content item 270G is only partially within the currently displayed displayable section, it is included.

FIGS. 1K-M illustrate updated views of the example GUI of FIG. 1A after receiving user input to scroll horizontally through tabs 106C-106E. FIGS. 1G-I and FIGS. 1K-1M) represent an animation that may play upon detecting a swipe gesture across the tabs in menu bar 106 (as shown in FIG. 1G). The animation shown in FIG. 1H displays a transition from a starting-point tab (the “Messenger” tab in FIG. 1K) to the subsequent tab (the “Notifications” tab in FIG. 1L). Further transitions may be displayed by the animations until reaching the stopping-point tab (the “More” tab, as shown in FIG. 1M).

The animation engine may compute and update the animation-state variables for the zoom animation such as, by way of example and not limitation: a default speed of zoom, the number of tabs, the current tab to display (computed based on the number of tabs and the magnitude of the swipe). In the example shown in FIGS. 1G and 1K, a horizontal swipe gesture is detected substantially over menu bar 106, and the horizontal distance traveled by the swipe gesture is computed as being around 40% of the horizontal width of menu bar 106. Since the user input triggered a tab transition animation displayed in content display region 104, at this point, corresponding animation-state variables (e.g., which tab to display, how many total tabs exist, how quickly to animate scrolling through the tabs) may be initialized, computed or updated, and stored in the GUI hierarchy (with respect to content display region 104). For both swipe gestures, the target tab may be computed as being the tab positioned at a distance from the current tab that is equivalent to 40% of the overall horizontal width of menu bar 106 (for FIG. 1G, the current tab is the “News Feed” tab, and the target tab two tabs down menu bar 106 is computed as being the “Messenger” tab; for FIG. 1K, the current tab is the “Messenger” tab, and the target tab is computed as being the “More” tab). This horizontal scrolling animation between tabs 106A-106E may be displayed in content display region 104 as a sliding motion of the GUI layout as shown in images 1G-1L. In particular embodiments, if the user opens and/or closes a tab, the animation-state variables for content display region 104 may be updated to reflect the change in the total number of tabs.

FIG. 1N illustrates an updated view starting from the example GUI of FIG. 1A. After detecting an “upward” vertical-scrolling gesture (e.g., a swipe gesture detected as beginning at a location within content display region 104 and moving upwards, which may be interpreted as user input instructing GUI 100 to scroll further down the news feed) generally over a portion of content display region 104, the application may apply the vertical-scrolling gesture user input and move the newsfeed content displayed in content display region 104 upwards in order to display additional news feed items (i.e., news feed item 110B).

Based on the data received from the input devices, the gesture manager may determine the input type as a vertical-scrolling gesture (by computing the path of the gesture based on multiple pairs of coordinates), compute the location of the gesture with respect to the current GUI layout, and identify the layer for content display region 104 to receive the user input. In this case, the only layer registered to receive an input type of a vertical-scrolling gesture is content display region 104, so once we know what general type of gesture was detected and where it occurred with respect to the current GUI layout, it is a simple matter to determine that the gesture should be applied to the layer for content display region 104.

As part of applying the vertical-scrolling gesture to content display region 104, the animation engine may determine that the gesture triggered an animation for header bar 107, which causes the header bar 107 to slide upwards and disappear in order to provide an increased area of content display region 104 in which news feed content may be displayed (while the user is scrolling “downward” and looking through the news feed). The animation engine may compute and update the animation-state variables for the animation of header bar 107 such as, by way of example and not limitation: a default speed of appearance/disappearance.

FIG. 1O illustrates an updated view starting from the example GUI of FIG. 1E. In FIG. 1E, content display region 104 has been scrolled up so as to display news feed item 110C, for which posted-content section 130C includes a video 132C and a scrollable text area 134C including a synopsis of the content captured in video 132C. The layer for video 132C is registered to receive tap gestures in order to control video playback, and the layer for scrollable text area 134C is registered to receive vertical-scrolling gestures. The height of scrollable text area 134C, however, if the mobile device is the size of a typical APPLE IPHONE, then it may be very likely that most users will exceed the perimeter of scrollable text area 134C when attempting a vertical-scrolling gesture to read through the text. The situation may become more complicated for the input thread to determine the intended gesture since the layer for content display region 104 (which is a parent node of the layer for scrollable text area 134C in the GUI hierarchy) is also registered to receive vertical-scrolling gestures.

Based on the data received from the input devices, the gesture manager may determine the input type as a “downward” vertical-scrolling gesture, compute the location of the gesture with respect to the current GUI layout, and identify the layer for content display region 104 to receive the user input. As part of applying the vertical-scrolling gesture to content display region 104, the animation engine may determine that the gesture triggered an animation for header bar 107, which causes the header bar 107 to slide downwards and appear in order to provide the user with an opportunity to either search through the news feed or to post their own content.

In particular embodiments, when the input thread identifies the input type as a scrolling-type gesture and computes the path of the gesture as passing through and extending beyond the perimeter of one layer that is registered to receive the identified input type into another layer that is registered to receive the identified input type, the input thread may identify the user input as two gestures: a first gesture to be applied to a first layer, based on the portion of the path that took place within the perimeter of the first layer, and a second gesture to be applied to a second layer, based on the portion of the path that took place within the perimeter of the second layer. For example, in the GUI layout illustrated in FIG. 1F, if the path of the gesture began at the bottom of scrollable text area 134C, moved upwards, and continued into the middle of video 132C, the input thread may determine two vertical-scrolling gestures: the first gesture applying to the layer for scrollable text area 134C to scroll up the text content in that GUI component and reveal more of the synopsis, and the second gesture applying to the layer for content display region 104 to scroll up content display region 104 and reveal the next news feed item after 110C.

In particular embodiments, when the input thread identifies the input type as a scrolling-type gesture and computes the path of the gesture as passing through and extending beyond the perimeter of one layer that is registered to receive the identified input type into another layer that is registered to receive the identified input type, the input thread may apply a gesture to only one of the layers—the layer within whose perimeter the starting point of the path was detected.

FIG. 2 illustrates a GUI hierarchy 200, which is a hierarchical organization of layers. GUI hierarchy 200 is represented as a tree data structure, comprising root node 100 (representing GUI 100), a number of intermediary nodes (e.g., node 104, representing content display region 104), and leaf nodes (e.g., node 106E, representing the “More” button 106E. Each layer represents a logical grouping of components of GUI 100 based on the example illustrated in FIG. 1A. Components of GUI 100 may be logically grouped on the basis of spatial positioning in the layout. For example, since header 107, news feed item 110A and news feed item 110B each appear within the perimeter of content display region 104, nodes 108, 110A, and 110B are represented by nodes in the GUI hierarchy that appear in the sub-tree originating at node 104. In particular embodiments, any component of GUI 100 that is referenced by and/or incorporated into a document (e.g., a HTML or XML document) may be represented by a node in GUI hierarchy 200 even though they are not visually represented in GUI 100. For example, a HTML document for GUI 100 may include a client-side script component associated with “More” button 106E that will display a pop-up menu of additional menu items if the user's finger performs a long hold gesture over the button—this pop-up menu component may be represented by a node in GUI hierarchy 200.

Each node of GUI hierarchy 200 may include attributes with layout information about a layer represented by the node, such as a set of coordinate pairs defining a perimeter for the layer, indications of one or more types of user input that may be applied to the layer (e.g., horizontal swipe gestures for menu bar 106, vertical swipe gestures for content display region 104, horizontal swipe gestures for scrolling image strip 130, tap gestures for image 134A, and long hold gestures for image 134Z), indications of one or more animations that may be applied to the layer (e.g., as shown for scrolling content display region 104, appearing/disappearing header 107, scrolling image strip 130, zooming image 134A, and pop-up menu 138), and a current position of the layer (e.g., a set of coordinates at which to position an anchor point for the layer, such as the upper-left-hand corner of a news feed item 110).

As shown in FIG. 2, each node representing a layer in the example GUI 100 shown in FIG. 1A is marked with attribute circles indicating one or more types of user input that may be applied to the layer. An attribute circle positioned at the top edge of a node indicates that the input type indicated by the attribute circle may be applied to the layer represented by that node. For example, node 104 represents content display region 104, which may be vertically scrolled, so node 104 is marked with an attribute circle “VS” positioned at the top edge of the node. In another example, node 106 represents menu bar 106, which may be horizontally scrolled, so node 106 is marked with an attribute circle “HS” positioned at the top edge of the node. An attribute circle positioned along the bottom edge of a node indicates that the input type indicated by the attribute circle may be applied to a layer in the sub-tree of GUI hierarchy 200 originating with that node. For example, node 106 represents menu bar 106—the sub-tree of GUI hierarchy originating with node 106 includes node 106C representing the “Messenger” button, which may be tapped, so node 106 is marked with an attribute circle “T” positioned along the bottom edge of the node. Of the layers represented by nodes in GUI hierarchy 200, the input types shown include: “VS” (vertical scrolling), “HS” (horizontal scrolling), “T” (tapping), “LH” (long hold), and “KY” (keyboard input). Certain layers do not include any interactive features, such as node 102; such nodes are marked with an attribute circle displaying the null symbol: Ø.

In particular embodiments, node attributes may include additional information about the layer represented by the node, such as a content ID for a content item being displayed by a GUI component of the layer, a content type for the content item, a timestamp for the content item, an a record of whether the user has interacted with the content item (and, if so, in what manner), social-graph information and/or social-networking information associated with the content item with respect to the user of the mobile device, etc.

As noted earlier, in particular embodiments, the animation-state variables and store them as part of the GUI hierarchy in association with the node representing the animated GUI component (e.g., as additional attributes associated with the node representing the animated GUI component, or in an attribute node connected by an edge to the node representing the animated GUI component). In the GUI hierarchy as shown in FIG. 2, the animation-state variables are denoted with an “AS” (for “animation state”). When the GUI hierarchy (including the animation-state variables) is subsequently copied from memory allocated for the input thread to memory allocated for the graphics thread, the graphics thread thereby receives instructions regarding how to draw the frames in accordance with the animations. In alternate embodiments, the input thread may add such animation-related node attributes or attribute nodes to the GUI hierarchy as user input triggering an animation is received; in such cases, the updated GUI hierarchy may then be copied from memory allocated for the input thread to memory allocated for the main thread. Some examples of information that may be tracked by using animation-state variables include: scale (x, y, and z), opacity, rotation (x, y, and z), skew (x and y), anchor point, perspective, width/height, effect (blur, color transformation: de-/saturation, greyscale, color rotation), and 3D transformations).

In particular embodiments, a GUI may have a number of displayable sections. A displayable section is a subsection of a larger GUI content region, such as a portion of a long scrolling list. The size of a displayable section is defined by how much of that region may appear in the GUI at any given time. For example, if a GUI configured for a display screen with 1136×640 pixels includes a fixed horizontal status bar at the top of the screen with a height of 20 pixels, a fixed horizontal menu bar at the bottom of the screen with a height of 40 pixels, and a scrollable content region in the middle, then the height of a displayable section of the scrollable content region is defined by the overall height of the display screen (1136 pixels) reduced by those portions of the GUI that cannot be occupied by the scrollable content region (total 60 pixels): 1076 pixels.

These displayable sections may represent, for example, tabs, views, pages, content items (e.g., photos), or menus of the GUI for the application, portions thereof, or any combination thereof. In particular embodiments, the computing device may render additional displayable sections of the GUI as well as the displayable section to be currently displayed. In particular embodiments, the currently displayed section may be associated with a current location of the GUI. In particular embodiments, as the user scrolls through the GUI, the boundary designations for displayable sections may be updated, based on the user's scrolling input. For example, if the user scrolls content display region 104 down by a distance that equals 40% of the height of content display region 104, the boundary designations for the displayable sections may be adjusted accordingly.

In particular embodiments, displayable sections may contain GUI components, some or all of which may include interactive features. In particular embodiments, a displayable section may be the same size and shape as the screen of the computing device. For example, if the screen of the computing device is a square with an area of four square inches, a displayable section may be a square with an area of four square inches. In alternative embodiments, the displayable sections may occupy a sub-region of the screen of the computing device, such as a particular window or frame within the GUI.

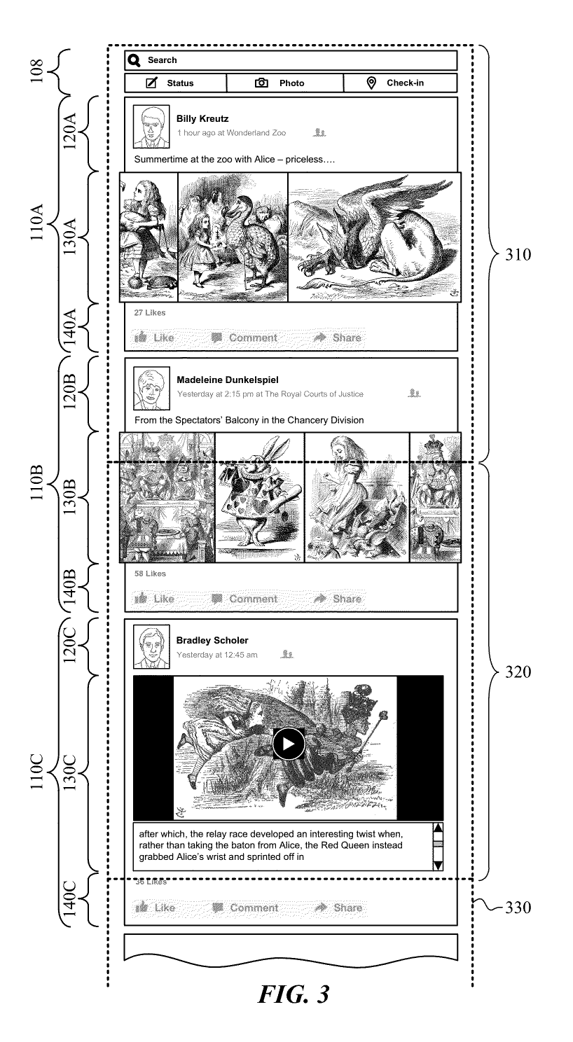

FIG. 3 illustrates example displayable sections of the GUI as shown in FIGS. 1A-1G and 1N-O. The newsfeed may be represented as a content list comprising a number of content items (e.g., the newsfeed stories). As displayed shown in FIGS. 1A-1G and 1M-1N, this content list is displayed within content display region 104; therefore, the dimensions of a displayable section of this content list are defined by the dimensions of content display region 104. As shown in FIG. 3, displayable section 310 of the newsfeed list includes the extent of the newsfeed list that is shown in FIG. 1C (the first displayable section of the newsfeed list), and displayable section 320 includes the extent of the newsfeed list that is shown in FIG. M (which is displayed after receiving user input scrolling down the newsfeed list). As shown in FIG. 3, interaction section 140C of content item 110C does not fit within displayable section 320, and so it is classified as also appearing within displayable section 330. Similarly, content item 110B and posted-content section 130B are also split between displayable sections 310 and 320.

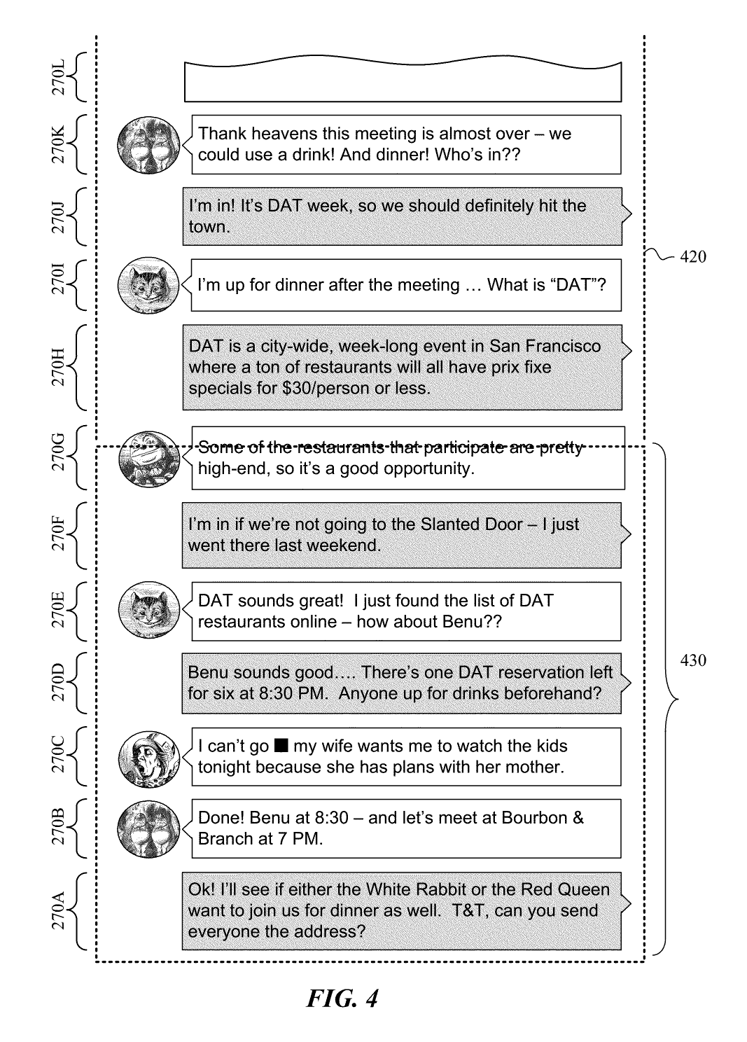

FIG. 4 illustrates example displayable sections of the example chat interface as shown in FIGS. 1I-K. The chat messages may be represented as a content list comprising a number of content items (e.g., the chat messages). As shown in FIG. 1J, this content list is displayed within an even more constrained displayable region that is defined by content display region 104, due to the persistent presence of chat UI header 107 and text entry field 275. As shown in FIG. 4, displayable section 430 of the message list includes the extent of the message list that is shown in FIG. 1J (the third displayable section of the newsfeed list). As shown in FIG. 4, message item 270G does not completely fit within displayable section 430, and so it is classified as also appearing within displayable section 420.

In particular embodiments, the main thread may select a caching pattern for the displayable sections in order to help the graphics thread efficiently display the GUI. In particular embodiments, the input thread may perform the task of selecting the caching pattern. In particular embodiments, the caching pattern may include a set of displayable sections, each of which may be said to be adjacent to the currently displayed section. Displayable sections included in the caching pattern may be immediately adjacent (e.g., there are no intervening displayable sections between two immediately adjacent displayable sections) or continuously adjacent (e.g., wherein every intervening adjacent displayable section between the currently displayed displayable section and the subject displayable section is included in the caching pattern) to one another with respect to the overall layout of the GUI. The caching pattern may thereby indicate which content items—typically, all of the content items for which at least a portion of the content item is included in at least one of the displayable sections (besides the one to be currently displayed) included in the caching pattern—should ideally be rendered and cached based upon received user input. For example, if the user input indicates that the user is slowly but steadily scrolling down a newsfeed reading each newsfeed item, the caching pattern may indicate that the computing device should render and cache at least two displayable sections worth of newsfeed items in a downward direction from the displayable section being currently displayed. If the user input indicates that the user very occasionally scrolls upward (but usually downward), the caching pattern may indicate that the computing device should also cache at least one displayable section worth of newsfeed items in an upward direction from the displayable section being currently displayed (in addition to rendering and caching at least two displayable sections worth of newsfeed items in a downward direction). In another example, if the user input indicates that the user is rapidly and steadily scrolling down a newsfeed and occasionally clicking the “Like” button for particular newsfeed stories, but not clicking to open any individual newsfeed story or to comment on one, the caching pattern may indicate that the computing device should render and cache at least eight displayable sections worth of newsfeed items in a downward direction from and adjacent to the displayable section being currently displayed (without caching any in an upward direction from the displayable section being currently displayed).

In particular embodiments, the caching pattern may be selected based at least in part on an estimated likelihood of one or more user inputs. For example, if the computing device has access to data indicating that the user will likely continue scrolling in the same direction after detecting a scroll by the user, the selected caching pattern may include adjacent displayable sections in the same direction as the detected scroll. In another example, if the computing device has access to data indicating that the user will likely scroll in the opposite direction after detecting a scroll by the scroll by the user, the selected caching pattern may include adjacent displayable sections in the opposite direction of the detected scroll. In yet another example, the computing device may estimate that the user is likely to scroll either in the same or opposite direction and select a caching pattern that includes adjacent displayable sections in both directions. As yet another example, it may be estimated that the user is likely to scroll either in the same or opposite direction, but is more likely to scroll in the same direction than in the opposite direction, so the caching pattern may include more displayable sections in the same direction than in the opposite direction. In particular embodiments, data used in estimating the likelihood of one or more future user inputs may be particular to the user, particular to a subset of users, or be associated with all possible users. For example, the data may be particular to users that are within a similar age range of the user, or may be particular to users that share other demographics or characteristics to the user. In particular embodiments, the data may have been collected by the computing device in response to past inputs by the user and/or other users. In alternative embodiments, the data may have been collected by a plurality of computing devices in response to past inputs by the user and/or other users. For example, the data may have been collected from users and stored on a social networking system. The data may have then been associated with a particular social-networking profile associated with the user from whom the data was collected. The estimated likelihood of success could then, in particular embodiments, be derived at least in part from this data.

As shown in FIG. 3 (displayable sections of a list of newsfeed stories), if a portion of a newsfeed list (e.g., displayable section 310) is currently being displayed, the portions of the newsfeed list included in displayable section 320 may be said to be immediately adjacent to currently displayed displayable section 310; accordingly, displayable section 330 may be said to be continuously adjacent to currently displayed displayable section 310. In another example, as shown in FIG. 4 (displayable sections of a list of chat messages), if displayable section 430 is currently being displayed, there may be only one displayable section (420) that is immediately adjacent to currently displayed displayable section 430 (e.g., if chat message 270A is the most recent message in the list).

In another example, as shown in FIGS. 1G-I and 1K-M (swiping through tabs), when the “Messenger” tab is currently being displayed, at least one displayable section of the “People” (e.g., contacts list) tab and at least one displayable section of the “Notifications” tab may each be said to be immediately adjacent to the particular displayable section of the “Messenger” tab that is currently being displayed. Therefore, if, when navigating to the “People” tab, the top of the list of contacts is always displayed (e.g., so as to display the Search People form box first and then display contacts in an order ranked by affinity), then the top-most displayable section of that list may be said to be immediately adjacent to whatever displayable section of the “Messenger” tab is currently being displayed. Furthermore, if, when navigating to the “Notifications” tab, the most recently viewed displayable section is always displayed (e.g., so as to ensure that the user is able to pick up where they left off with respect to viewing their incoming notifications), then that most recently viewed displayable section of that list may be said to be immediately adjacent to whatever displayable section of the “Messenger” tab is currently being displayed. Accordingly, at least one displayable section of the “News Feed” tab and at least one displayable section of the “More” tab may each be said to be continuously adjacent to the particular displayable section of the “Messenger” tab that is currently being displayed.

The caching pattern may include displayable sections that are adjacent to the currently displayed section in one or more directions based at least in part on one or more types of user input. The user inputs may be, for example, one or more touches, taps, scrolls, pinch-ins, pinch-outs, or some combination thereof. For example, if a scroll input by the user is detected moving parallel to the screen in a particular direction, the caching pattern may include one or more displayable sections in the same direction as the user input. As another example, if a pinch-in gesture by the user is detected, the caching pattern may include one or more displayable sections surrounding the currently displayed section.

In particular embodiments, if none of the content items at least partially included in the displayable sections included in the caching pattern have been cached, then all of any such content items may be rendered. After being rendered, the portion of the content list included in the displayable section to be currently displayed may be drawn into a frame buffer of the computing device, while the content items in the other displayable sections may be cached (e.g., as pixel bitmaps representing portions of the larger GUI, as a series of drawing commands that may be executed in order to replicate the content (e.g., ‘draw a rectangle of this size and this color, then draw particular text on top of the rectangle, then draw a particular image below the rectangle”), or in a descriptive format (e.g., “a shaded gradient that proceeds from color A to color B”)) in a non-transitory memory of the computing device. If the content items at least partially included in the displayable section to be currently displayed were previously rendered and cached, the graphics thread may retrieve such content and write at least a portion of the previously rendered and cached content to the frame buffer.

After drawing the currently displayed section into the frame buffer and caching the other rendered displayable sections, the computing device may detect a user input. The computing device may then attempt to retrieve rendered images for the content items from the cache and draw it into the frame buffer. For example, the computing device may have detected a scroll gesture input by the user in a particular direction, rendered the currently displayed section and a displayable section adjacent to the currently displayed section in that particular direction, drawn the currently displayed section into the frame buffer, and cached the adjacent displayable section. The computing device may then detect another scroll by the user in the same particular direction. The computing device may then retrieve one or more content items in the adjacent displayable section from the cache and draw it into the frame buffer. In some embodiments, the user may have scrolled so slightly that, upon processing the received user input, the input thread may determine that the caching pattern remains the same, and no additional content items need be rendered and cached. In particular embodiments, if, as described above, the boundary designations for the displayable sections are updated in accordance with the user's scrolling input, one or more additional content items may be rendered and cached.

In particular embodiments, the computing device may only render and cache that portion of the GUI that is essential to updating the GUI and then later retrieve the cached portion for the rendered content items in a particular displayable section and composite the cached portion with the currently rendered GUI.

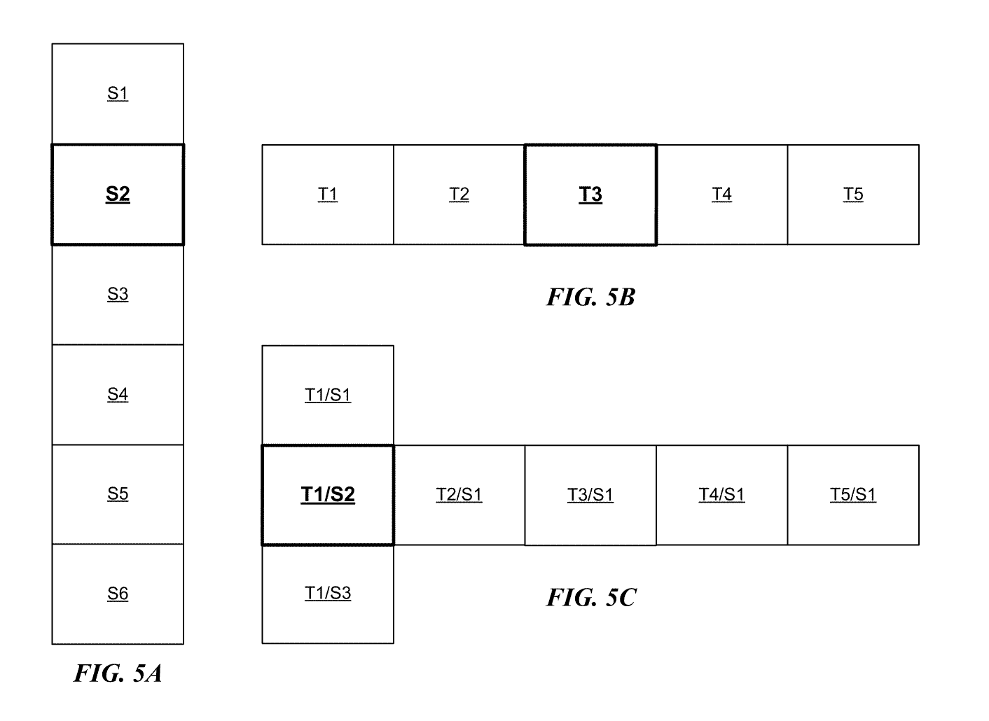

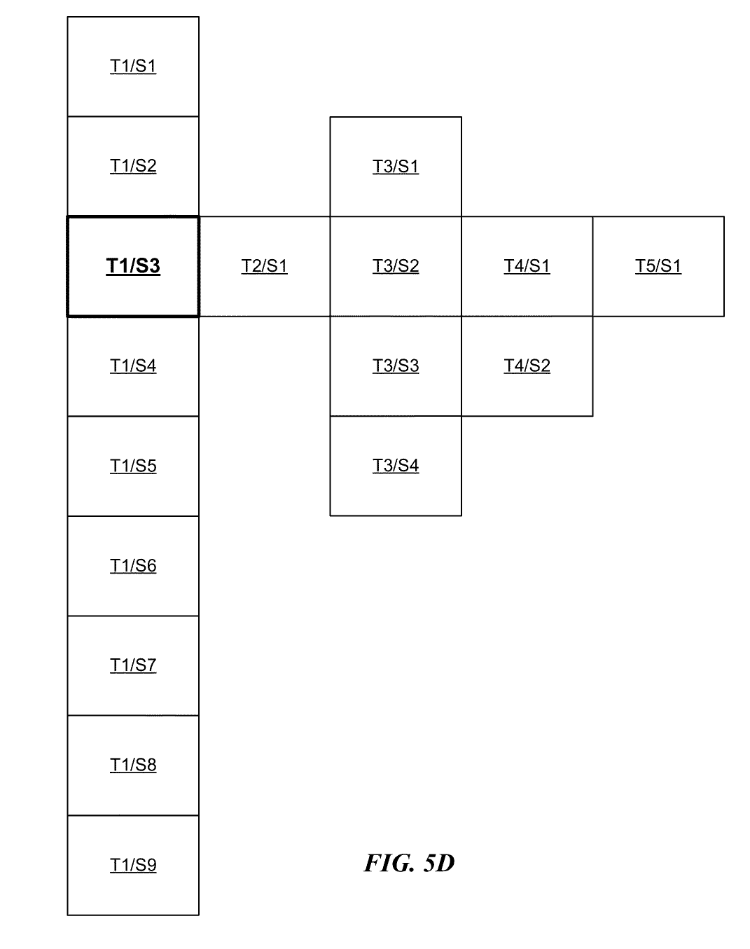

FIGS. 5A-D illustrate example caching patterns for generating and caching displayable sections. In the example shown in FIG. 5A, for a very long list of content items (e.g., a newsfeed) where the user is rapidly scrolling downwards through the list, the selected caching pattern includes six displayable sections, of which displayable section S2 is being currently displayed: four downwards adjacent displayable sections are included while only one upward displayable section is included.

In the example shown in FIG. 5B, for a GUI including five tabs, where the user is using a swiping gesture to navigate between the tabs, the selected caching pattern includes five displayable sections, of which displayable section T3 is being currently displayed: two adjacent displayable sections are included in each direction: two to the left and two to the right.

The example caching pattern shown in FIG. 5C is a bit more complex, since it includes displayable sections cached along two axes. For example, this caching pattern may have been applied to the GUI as illustrated in FIG. 1M, where displayable section T1/S2 (as shown in FIG. 3, displayable section 320 of the “News Feed” tab) is being currently displayed. The caching pattern of FIG. 5C includes a displayable section for each tab, in case the user navigates to another tab, and one upward displayable section and one downward displayable section.

Finally, the example caching pattern shown in FIG. 5D is the most complex example, since it includes displayable sections cached along multiple axes. In this case, the input thread may have selected this caching pattern based on not only the received user input, but also anticipated patterns of use, for example: (1) the user input indicates that the user is somewhat steadily scrolling down the “News Feed” (T1) while occasionally scrolling upwards, (2) historically, the user tends to use the “Search” form when looking for a particular contact (so therefore, there is no point in caching any displayable sections beyond the one that includes the “Search” form, (3) that the user is in the middle of reading a chat thread (and most recently read a message in the thread that is currently in displayable section T3/S2), and (4) that the user has received two displayable sections worth of notifications.

Selection of a particular caching pattern, as well as the number and type of content elements prepared and persistently stored in memory, may vary based on one or more factors:
the amount of available memory or the CPU's ability to perform concurrent rendering on parallel threads—in these cases, the computing device may cut back on utilization of caching patterns in order to conserve resources;
user behavior (direction of scrolling/switching, velocity of scrolling/switching, frequency of scrolling/switching, frequency of performing other operations in between scrolling/switching gestures);
whether the application is still in the process of resuming from the background; and
content attributes (the computing device may cut back on utilization of caching patterns when the content is highly time-sensitive, when the content is supposed to be secure content (e.g., only accessible after immediate login), based on whether the content is expensive or cheap to render, and based on whether the content is complex or simple).

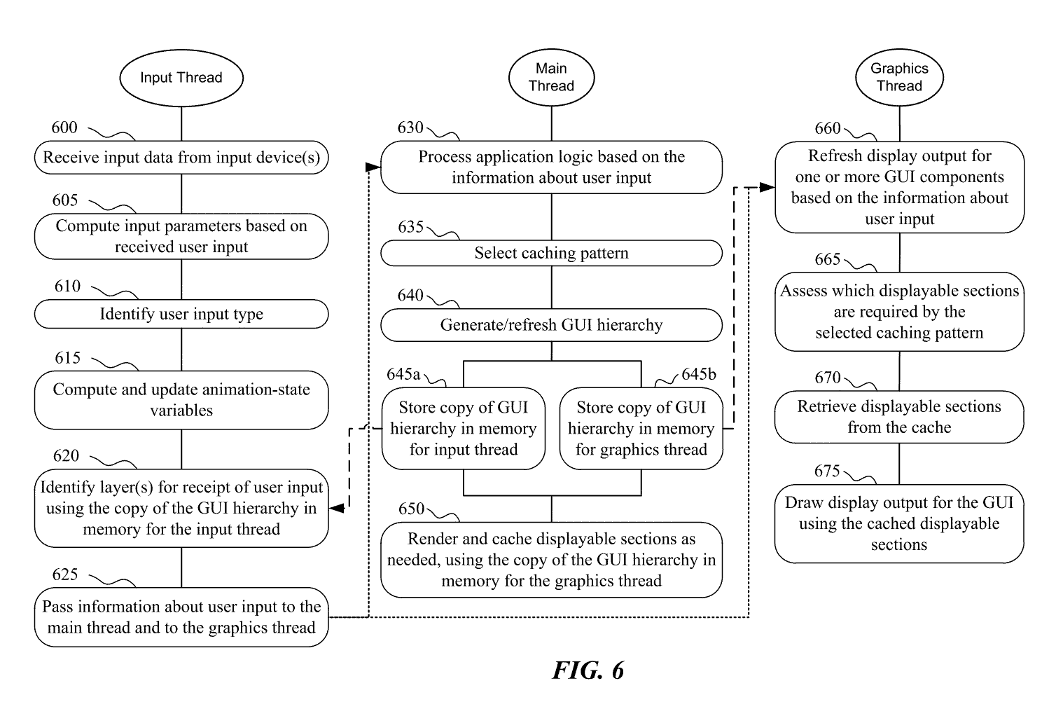

FIG. 6 illustrates an example method for asynchronous execution of instructions for one application by multiple threads. As illustrated in FIG. 6, steps of the method are performed by three different threads executing on a computing device: the input thread, the main thread, and the graphics thread. Steps of the method are described herein presume that the application has already been launched, is executing in the foreground, that the main thread has already (1) generated at least an initial GUI hierarchy and (2) stored copies of the GUI hierarchy in memory for the input thread and in memory for the graphics thread. And as described above, in the examples described herein, the gesture manager handles execution of all of its tasks using the input thread.

The method may begin at step 600, where the gesture manager receives input data from one or more input devices, such as a touchscreen. The input data may include one or more pairs of coordinates where touch input was sensed, a start time, and an end time.

At step 605, the gesture manager computes user input parameters using the received data. The parameters may include a duration of time associated with the user input based on the received data. The parameters may include a location for the user input, wherein the location may be a single location associated with a pair of coordinates or a path associated with multiple pairs of coordinates. In the case of a scrolling gesture, the parameters may include an axis of scrolling (e.g., vertical or horizontal), a direction (e.g., up, down, left, right), a scrolled distance (computed with respect to the axis of scrolling), and (possibly with respect to portions of the path) velocity and/or acceleration/deceleration. In particular embodiments, techniques described in U.S. patent application Ser. No. 13/689,598, titled “Using Clamping to Modify Scrolling” and filed 29 Nov. 2012, may be applied to enhance methods described herein by clarifying vague scrolling-type gestures (e.g., to assess and apply an axis of scrolling, a direction of scrolling, and compute the scrolled distance when the user's finger does not move in a perfectly straight line and/or does not move in a direction perfectly orthogonal to a particular axis of scrolling).

At step 610, the gesture manager identifies a type of the user input based on the location and the duration of time associated with the user input. If the location is a single location and the duration is short, the gesture manager may identify the type of the user input as a tap gesture. If the location is a single location and the duration is long, the input thread may identify the type of the user input as a long hold gesture. If the location is a path, the gesture manager may identify the type of the user input as a scrolling-type gesture (which may be vertical, horizontal, etc.). In particular embodiments, if the location is an extremely short path, the input thread may treat the location as a single location, rather than a path.

At step 615, the input thread may compute and update animation-state variables in accordance with a type of animation specified for a particular GUI component. In some cases, the input thread may simply compute and update animation-state variables for an existing animation in accordance with the specified type of animation; in some cases, the input thread may also take into account user input triggering or modifying the animation.

In particular embodiments, specification of the animation may be accomplished by way of a simple programming language that specifies different types of behavior for different types of animation. For the animation illustrated in FIGS. 1G-L (when the user scrolls horizontally through tabs 106A-106E), example programming code specifying the animation is shown below:

indicator.x=pager.x/number_of_pages;

where pager.x is a variable representing the x (or horizontal scroll) position of the pager layer, and number_of_pages is a variable (representing the number of tabs). In particular embodiments, the variable number_of_pages may be set by the main thread when it creates the layer tree.

For the animation illustrated in FIGS. 1D-F (when the user zooms in on image 134A), example programming code specifying the animation is shown below for an embodiment where the main thread handles execution of tasks to respond to user input:
var target;
let f=spring(k=0.5, rest_point=target);
image.x=lerp(f, zoomed_x, resting_x);
image.y=lerp(f, zoomed_x, resting_y);
image.scale=lerp(f, zoomed_x, resting_scale);
   In this example, variable f is configured with a particular constant k as referenced by Hooke's law. The target variable (representing the natural resting spot of the spring) may be updated by the main thread in response to receiving an indication that a longpress gesture input was received. The value of variable f may then be used to do a linear interpolation between the two pre-computed layouts (x, y, scale) for the image in its resting and zoomed states.

In an alternate embodiment, where the input thread handles execution of tasks to respond to user input, example programming code specifying the animation is shown below for the animation illustrated in FIGS. 1D-F:
let gesture=longpress(phase=bubble, duration=600 ms);
let target=if gesture.state==STARTED then 0 else 1;
let f=spring(k=0.5, rest_point=target);
image.x=lerp(f, zoomed_x, resting_x);
image.y=lerp(f, zoomed_x, resting_y);
image.scale=lerp(f, zoomed_x, resting_scale);
   In this example, the longpress gesture input (parameterized by gesture dispatch phase and duration) triggers the animation and sets the target value for the spring either to 0 (e.g., fully zoomed-out state) if the gesture is active, or to 1 (e.g., resting state) if the longpress gesture has not been detected, or has not yet activated (e.g., a press gesture has just been detected but hasn't lasted long enough to qualify as a longpress gesture yet), or has been canceled (e.g., due to the press gesture terminating before qualifying as a longpress gesture, or due to receiving touch events from other fingers).

At step 620, the gesture manager identifies one or more layers of the GUI hierarchy for receipt of the user input. Each layer of the GUI hierarchy may be associated with a set of coordinate pairs defining a perimeter for the layer. In addition, each layer of the GUI hierarchy may be associated with one or more types of user input (as shown in FIG. 2). The gesture manager may traverse its copy of the GUI hierarchy, wherein at each layer, the gesture manager makes a determination based on (1) whether the location for the user input is substantially within the perimeter for the current layer, and (2) whether the identified type for the user input matches one of the types of user input associated with the current layer. If both conditions are true, and if the current layer is a leaf node in the GUI hierarchy, the gesture manager identifies the current layer for application of user input. If both conditions are true, and if the current layer is not a leaf node, the gesture manager determines whether any child nodes of the current layer are registered to receive user input of the type identified in step 610—if not, then the gesture manager identifies the current layer for application of user input; otherwise the gesture manager continues to traverse the GUI hierarchy. In particular embodiments, as the gesture manager traverses the GUI hierarchy, a temporary copy of the GUI hierarchy may be generated that includes only those nodes having some relation to the identified layers.

At step 625, the input thread passes, to the main thread and to the graphics thread, information about the user input. By passing information needed to update the GUI directly from the input thread to both the graphics thread and to the main thread, the graphics thread is able to proceed immediately (and asynchronously) with updating the GUI in response to the user input.

The information passed to the graphics thread and the main thread may comprise the computed user input parameters, the identified type of the user input, the duration of time associated with the user input, the layers of the GUI hierarchy identified for receipt of the user input, and/or any additional information about the user input. For example, in the case where a scrolling-type gesture was identified, the input thread may send information about the gesture to the graphics thread and the main thread at the same time, such that both of those threads are able to asynchronously proceed with processing the information about the user input. Therefore, while the main thread is processing a notification from the input thread that a scrolling-type gesture has been detected and determining whether to update the content displayed in existing layers and/or to generate content to fill in new layers, the graphics thread may concurrently translate the content displayed in the layer for content display region 104 (the scrollable region) by the computed scrolled distance and re-render the display output. In particular embodiments, the input thread may only send information to the graphics thread for particular types of user input resulting in simple/straightforward GUI updates (e.g., user input that triggers an animation or video playback or user input representing a command to move an object or highlight an image as being selected); in such embodiments, the input thread may send the information about the user input to only the main thread when the user input would result in a more complex GUI modification (e.g., generation of new content to fill in new layers).

At step 630, the main thread processes business logic for the application using the identified gesture. At step 635, the main thread selects a caching pattern for displayable sections of the GUI, based on the current user input. In particular embodiments, the main thread may also assess other information that may be used by the graphics thread to determine how to apply the caching pattern. In particular embodiments, the input thread may perform the task of selecting the caching pattern.

At step 640, the main thread generates and/or refreshes the GUI hierarchy, and in steps 645a and 645b, the main thread stores a copy of the GUI hierarchy in memory for the input thread and a copy of the GUI hierarchy in memory for the graphics thread, respectively. As noted earlier, in particular embodiments, the main thread may initialize such animation-state variables and store them as part of the GUI hierarchy in association with the node representing the animated GUI component (e.g., as additional attributes associated with the node representing the animated GUI component, or in an attribute node connected by an edge to the node representing the animated GUI component). When the GUI hierarchy (including the animation-state variables) is subsequently copied from memory allocated for the input thread to memory allocated for the graphics thread, the graphics thread thereby receives instructions regarding how to render the frames in accordance with the animations. In alternate embodiments, the input thread may add such animation-related node attributes or attribute nodes to the GUI hierarchy as user input triggering an animation is received; in such cases, the updated GUI hierarchy may then be copied from memory allocated for the input thread to memory allocated for the main thread.

In step 650, the main thread may then render (and cache as needed) displayable sections included in the caching pattern, using the copy of the GUI hierarchy that has been stored in memory for the main thread. In particular embodiments, the graphics thread may handle rendering the displayable sections included in the caching pattern.

At step 660, the graphics thread refreshes the display output either for the entire UI or for one or more components of the GUI, using the information received from the input thread and the most recent copy of the GUI hierarchy. At step 665, the graphics thread may assess which displayable sections are required by the selected caching pattern, and retrieve those displayable sections from the cache (step 670).

Finally, in step 675, the graphics thread may re-draw and/or update the display output again.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

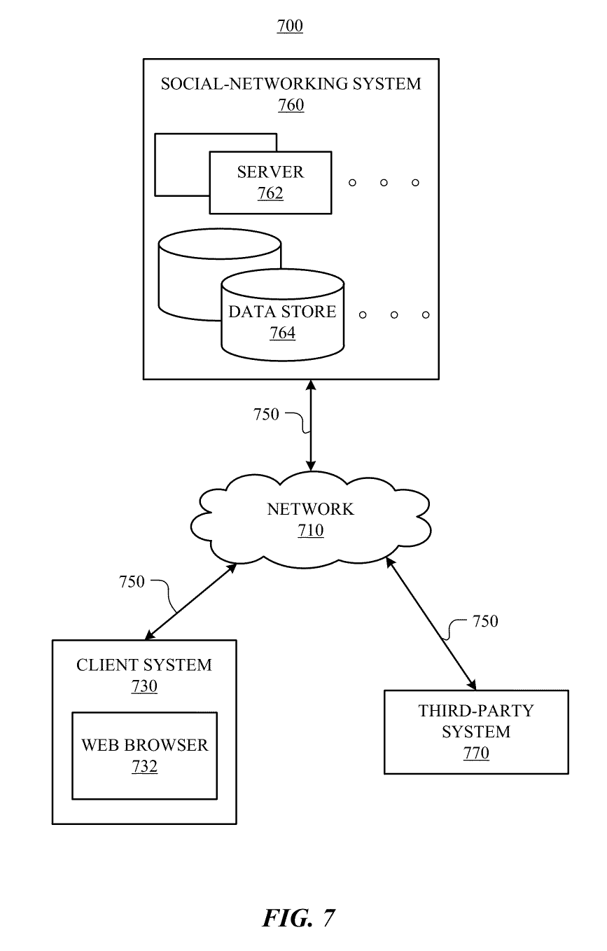

FIG. 7 illustrates an example network environment 700 associated with a social-networking system. Network environment 700 includes a user 701, a client system 730, a social-networking system 760, and a third-party system 770 connected to each other by a network 710. Although FIG. 7 illustrates a particular arrangement of user 701, client system 730, social-networking system 760, third-party system 770, and network 710, this disclosure contemplates any suitable arrangement of user 701, client system 730, social-networking system 760, third-party system 770, and network 710. As an example and not by way of limitation, two or more of client system 730, social-networking system 760, and third-party system 770 may be connected to each other directly, bypassing network 710. As another example, two or more of client system 730, social-networking system 760, and third-party system 770 may be physically or logically co-located with each other in whole or in part. Moreover, although FIG. 7 illustrates a particular number of users 701, client systems 730, social-networking systems 760, third-party systems 770, and networks 710, this disclosure contemplates any suitable number of users 701, client systems 730, social-networking systems 760, third-party systems 770, and networks 710. As an example and not by way of limitation, network environment 700 may include multiple users 701, client system 730, social-networking systems 760, third-party systems 770, and networks 710.

In particular embodiments, user 701 may be an individual (human user), an entity (e.g., an enterprise, business, or third-party application), or a group (e.g., of individuals or entities) that interacts or communicates with or over social-networking system 760. In particular embodiments, social-networking system 760 may be a network-addressable computing system hosting an online social network. Social-networking system 760 may generate, store, receive, and send social-networking data, such as, for example, user-profile data, concept-profile data, social-graph information, or other suitable data related to the online social network. Social-networking system 760 may be accessed by the other components of network environment 700 either directly or via network 710. In particular embodiments, social-networking system 760 may include an authorization server (or other suitable component(s)) that allows users 701 to opt in to or opt out of having their actions logged by social-networking system 760 or shared with other systems (e.g., third-party systems 770), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users of social-networking system 30 through blocking, data hashing, anonymization, or other suitable techniques as appropriate. Third-party system 770 may be accessed by the other components of network environment 700 either directly or via network 710. In particular embodiments, one or more users 701 may use one or more client systems 730 to access, send data to, and receive data from social-networking system 760 or third-party system 770. Client system 730 may access social-networking system 760 or third-party system 770 directly, via network 710, or via a third-party system. As an example and not by way of limitation, client system 730 may access third-party system 770 via social-networking system 760. Client system 730 may be any suitable computing device, such as, for example, a personal computer, a laptop computer, a cellular telephone, a smartphone, or a tablet computer.

This disclosure contemplates any suitable network 710. As an example and not by way of limitation, one or more portions of network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 710 may include one or more networks 710.

Links 750 may connect client system 730, social-networking system 760, and third-party system 770 to communication network 710 or to each other. This disclosure contemplates any suitable links 750. In particular embodiments, one or more links 750 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 750 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout network environment 700. One or more first links 750 may differ in one or more respects from one or more second links 750.

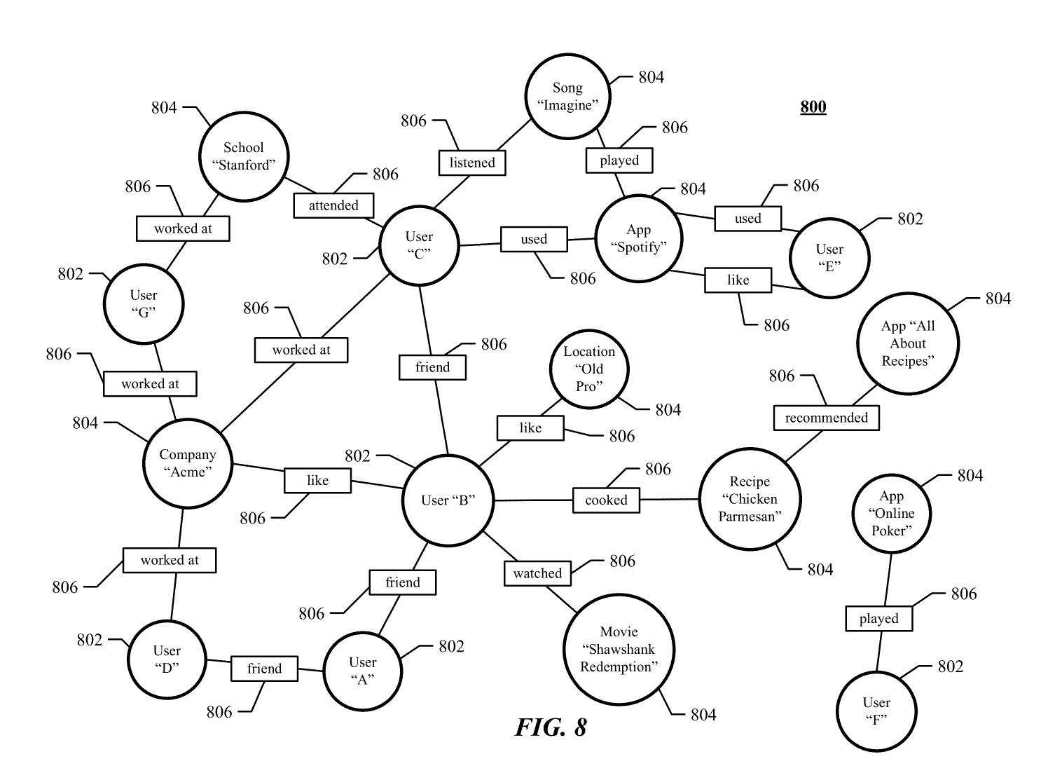

FIG. 8 illustrates example social graph 800. In particular embodiments, social-networking system 760 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a social-networking system 760, client system 730, or third-party system 770 may access social graph 800 and related social-graph information for suitable applications. The nodes and edges of social graph 800 may be stored as data objects, for example, in a data store (such as a social-graph database). Such a data store may include one or more searchable or queryable indexes of nodes or edges of social graph 800.

In particular embodiments, a user node 802 may correspond to a user of social-networking system 760. As an example and not by way of limitation, a user may be an individual (human user), an entity (e.g., an enterprise, business, or third-party application), or a group (e.g., of individuals or entities) that interacts or communicates with or over social-networking system 760. In particular embodiments, when a user registers for an account with social-networking system 760, social-networking system 760 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with social-networking system 760. In particular embodiments, a user node 802 may be associated with information provided by a user or information gathered by various systems, including social-networking system 760. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more webpages.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 760 or a third-party website associated with a web-application server); an entity (such as, for example, a person, business, group, sports team, or celebrity); a resource (such as, for example, an audio file, video file, digital photo, text file, structured document, or application) which may be located within social-networking system 760 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including social-networking system 760. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to social-networking system 760. Profile pages may also be hosted on third-party websites associated with a third-party server 770. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 770. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 730 to send to social-networking system 760 a message indicating the user's action. In response to the message, social-networking system 760 may create an edge (e.g., a check-in-type edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, social-networking system 760 may send a “friend request” to the second user. If the second user confirms the “friend request,” social-networking system 760 may create an edge 806 connecting the first user's user node 802 to the second user's user node 802 in social graph 800 and store edge 806 as social-graph information in one or more of data stores 764. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to an edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social-networking system 760 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 760 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social-networking system 760 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social-networking system 760 may create an edge 806 between a user node 802 and a concept node 804 in social graph 800. As an example and not by way of limitation, a user viewing a concept-profile page (such as, for example, by using a web browser or a special-purpose application hosted by the user's client system 730) may indicate that he or she likes the concept represented by the concept node 804 by clicking or selecting a “Like” icon, which may cause the user's client system 730 to send to social-networking system 760 a message indicating the user's liking of the concept associated with the concept-profile page. In response to the message, social-networking system 760 may create an edge 806 between user node 802 associated with the user and concept node 804, as illustrated by “like” edge 806 between the user and concept node 804. In particular embodiments, social-networking system 760 may store an edge 806 in one or more data stores. In particular embodiments, an edge 806 may be automatically formed by social-networking system 760 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by social-networking system 760 or shared with other systems (e.g., third-party system 770). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 770, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 762 may be authorization/privacy servers for enforcing privacy settings. In response to a request from a user (or other entity) for a particular object stored in a data store 764, social-networking system 760 may send a request to the data store 764 for the object. The request may identify the user associated with the request and may only be sent to the user (or a client system 730 of the user) if the authorization server determines that the user is authorized to access the object based on the privacy settings associated with the object. If the requesting user is not authorized to access the object, the authorization server may prevent the requested object from being retrieved from the data store 764, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

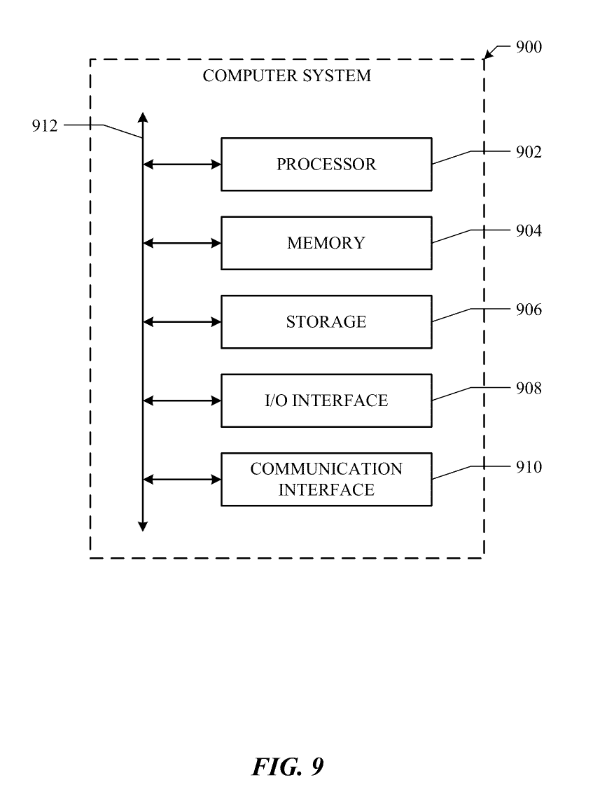

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, executing, by a main thread, instructions to:
generate an object representation of a graphical user interface (GUI) for an application; and
provide a copy of the object representation of the GUI to a graphics thread;
determine a plurality of displayable sections to render based at least on user input information, a current location with respect to the GUI, and a caching pattern, wherein the caching pattern comprises a first section and one or more second sections adjacent to the first section in one or more directions;
render a first one of the displayable sections and one or more second ones of the displayable sections based at least in part on the determination, wherein the first displayable section and the second displayable sections each comprise display output that fills at least a portion of a screen of the computing device;
cache the second rendered sections in a non-transitory memory of the computing device; and
by the computing device, asynchronously executing, by the graphics thread, instructions to draw the first rendered section into a frame buffer of the computing device.

2. The method of claim 1, wherein the second rendered sections are generated in one or more of the directions.

3. The method of claim 1, wherein the caching pattern is determined based at least in part on the user input information.

4. The method of claim 3, wherein the caching pattern is determined based at least in part on an estimated likelihood of receiving different types of additional user input information.

5. The method of claim 3, wherein the user input information comprises a scroll gesture in the direction in which one or more of the second rendered sections are rendered.

6. The method of claim 5, wherein the user input information comprises a direction of scrolling for the GUI, and wherein one or more of the directions corresponds to the direction of scrolling for the GUI.

7. The method of claim 6, wherein the caching pattern comprises a plurality of the second rendered sections in the direction of scrolling for the GUI, and wherein a rendered section for the end of a scrolling region of the GUI overlaps with an adjacent one of the second rendered sections.

8. The method of claim 3, wherein the user input information comprises a selected tab of the GUI, and wherein one or more of the directions corresponds to the selected tab of the GUI.

9. The method of claim 8, wherein at least one of the second rendered sections corresponds to a different tab of the application.

10. The method of claim 1, further comprising asynchronously executing, by the graphics thread, instructions to:
in response to receiving additional user input information:
retrieve from the memory one of the second rendered sections; and
draw into the frame buffer the retrieved second rendered section.

11. The method of claim 10, further comprising asynchronously executing, by the main thread, instructions to:
determine one or more new displayable sections to render based at least on the additional user input information and the caching pattern;
render the new displayable sections based at least in part on the determination; and
cache at least one of the new rendered sections.

12. The method of claim 11, further comprising asynchronously executing, by the graphics thread, instructions to:
draw one of the new rendered sections into the frame buffer.

13. One or more computer-readable non-transitory storage media embodying software that is operable when executed by one or more processors of a computing device to:
execute, by a main thread, instructions to:
generate an object representation of a graphical user interface (GUI) for an application; and
provide a copy of the object representation of the GUI to a graphics thread;
determine a plurality of displayable sections to render based at least on user input information, a current location with respect to the GUI, and a caching pattern, wherein the caching pattern comprises a first section and one or more second sections adjacent to the first section in one or more directions;
render a first one of the displayable sections and one or more second ones of the displayable sections based at least in part on the determination, wherein the first displayable section and the second displayable sections each comprise display output that fills at least a portion of a screen of the computing device;
cache the second rendered sections in a non-transitory memory of the computing device; and
asynchronously execute, by the graphics thread, instructions to draw the first rendered section into a frame buffer of the computing device.

14. The media of claim 13, wherein the second rendered sections are generated in one or more of the directions.

15. The media of claim 13, wherein the caching pattern is determined based at least in part on the user input information.

16. The media of claim 15, wherein the caching pattern is determined based at least in part on an estimated likelihood of receiving different types of additional user input information.

17. The media of claim 15, wherein the user input information comprises a scroll gesture in the direction in which one or more of the second rendered sections are rendered.

18. The media of claim 17, wherein the user input information comprises a direction of scrolling for the GUI, and wherein one or more of the directions corresponds to the direction of scrolling for the GUI.

19. The media of claim 18, wherein the caching pattern comprises a plurality of the second rendered sections in the direction of scrolling for the GUI, and wherein a rendered section for the end of a scrolling region of the GUI overlaps with an adjacent one of the second rendered sections.

20. A computing device comprising one or more processors and a memory coupled to the processors comprising instructions executable by the processors, the processors being operable when executing the instructions to:
execute, by a main thread, instructions to:
generate an object representation of a graphical user interface (GUI) for an application; and
provide a copy of the object representation of the GUI to a graphics thread;
determine a plurality of displayable sections to render based at least on user input information, a current location with respect to the GUI, and a caching pattern, wherein the caching pattern comprises a first section and one or more second sections adjacent to the first section in one or more directions;
render a first one of the displayable sections and one or more second ones of the displayable sections based at least in part on the determination, wherein the first displayable section and the second displayable sections each comprise display output that fills at least a portion of a screen of the computing device;
cache the second rendered sections in a non-transitory memory of the computing device; and
asynchronously execute, by the graphics thread, instructions to draw the first rendered section into a frame buffer of the computing device.
